(19) United States
(12) Patent Application Publication
(10) Pub. No.: US 2021/0028412 A1
(43) Pub. Date: Jan. 28, 2021

(54) BATTERY FOR AN AT LEAST PARTIALLY ELECTRICALLY OPERATED/DRIVEN FUNCTIONAL DEVICE AND FUNCTIONAL DEVICE

(71) Applicant: AUDI AG, Ingolstadt (DE)

(72) Inventors: Christian Gert VOIGT, Usingen (DE); Christoph GLASSL, Denkendorf (DE); Florian SCHELS, Seubersdorf (DE); Dirk HOEFNER, Wellheim (DE); Steffen WALTER, Gaimersheim (DE); Michael BAYER, Großmehring (DE); Tamas GYULAI, Pfaffenhofen an der Ilm (DE); Waldemar BAUER, Manching (DE)

(73) Assignee: AUDI AG, Ingolstadt (DE)

(21) Appl. No.: 16/935,526

(22) Filed: Jul. 22, 2020

(30) Foreign Application Priority Data
Jul. 25, 2019 (DE) 102019211093.2

(51) Int. Cl. H01M 2/02

(52) U.S. Cl. CPC H01M 2/0245; H01M 2220/20

(57) ABSTRACT

A battery for an at least partially electrically operated functional device, including at least one battery cell module, in each of which a predetermined number of battery cells is clamped by a mechanical clamping device to form a cell stack. The clamping device transmits a traction force or a contact pressure corresponding to the traction force to the cell stack by delimiting elements and traction elements. A frame element is arranged in each case between at least two or some or each of the battery cells and/or the respective terminal battery cell and the delimiting element is arranged adjacent to the respective terminal battery cell and associated with it. The frame element includes a circumferential part and a free volume delimited by the circumferential part.

### FIELD

The invention relates to a battery for an at least partially electrically operated/driven functional device, comprising at least one battery cell module, in each of which a predetermined number of battery cells is clamped by means of a mechanical clamping device to form a cell stack. The predetermined number is preferably one, two, three, or higher than three here. The clamping device is designed to transmit a traction force or a contact pressure corresponding to the traction force to the battery cells by means of delimiting elements and traction elements. In addition, the invention relates to a functional device having such a battery.

### BACKGROUND

Batteries for at least partially electrically driven functional devices generally comprise a plurality of battery cells which are electrically interconnected and which can be designed, for example, as prismatic cells or as pouch cells. Due to the electrical interconnection of the battery cells, such a battery can provide an electrical voltage of greater than 60 V and in particular several hundred volts, for example, on the basis of multiple battery cells, because of which it is also referred to as a high-voltage battery. The battery cells are preferably arranged on one another to form cell stacks in such a way that the cell poles or electrical terminals or contact poles of the battery cells can be electrically interconnected without additional construction expenditure. The interconnection can be carried out, for example, by welding on an electrically conductive contacting means, for example, an electrically conductive rail or a so-called busbar. In pouch cells, the electrical contacts generally consist of foils that are fastened to conductor rails or busbars. A plurality of battery cell modules having cell stacks, which can in turn be electrically interconnected by means of cell module connectors, can be arranged in such a battery.

The battery cells of such a battery swell due to operation (so-called swelling), as a result of which a deformation of the individual battery cells and ultimately a deformation of the cell stack constructed from battery cells takes place, which in particular results in relative movements between the cell poles and the electrically conductive rails which are welded or permanently connected in another manner to the cell poles. This deformation of the cell stack is generally counteracted by means of mechanical clamping devices.

Various batteries of the type described at the outset are known from the prior art, for example, for use in at least partially electrically driven motor vehicles, having battery cells arranged to form cell stacks. For example, US 2010/0304203 A1, US 2015/0017504 A1, and DE 10 2011 106 690 A1 each disclose battery cells arranged to form a cell stack, which are held together by holding elements or clamping devices.

In addition, for example, WO 2018/022907 A1 describes compressible intermediate layers arranged between the individual battery cells. These intermediate layers are configured to allow operational swelling of the battery cells in moderation, wherein end plates or delimiting elements are configured to keep a total pressure acting on the battery cells constant.

In the arrangements described in the prior art, the clamping disadvantageously results in a high pressure load on all components of the cell stack. In addition, in the known arrangements, the swelling of the individual battery cells disadvantageously results in an elongation of the entire cell stack, since the swelling-induced deformation of a battery cell is transmitted directly to the adjoining battery cells. In other words, the swelling of the battery cells leads to an external expansion of the entire cell stack, whereby this in turn causes a relative movement between the cell poles of the individual battery cells and the rails or busbars connecting the cell poles in an electrically conductive manner.

Since the battery cells in the known arrangements either directly abut one another or are mechanically coupled to one another by means of a compressible intermediate layer, the mentioned deformation can add up inside the cell stack, whereby battery cells located farther outward in the cell stack are deformed more strongly than internal battery cells. In addition, since not all of the battery cells in a cell stack swell equally, but rather the individual battery cells differ in terms of their swelling characteristics depending on their aging state, an inhomogeneous deformation and accompanying pressure load occur in the interior of the cell stack in the known arrangements.

Overall, the known arrangements thus result in the disadvantage that there is uneven mechanical loading of the individual battery cells of a cell stack in the event of operational deformation of the battery cells, for example, due to swelling.

### SUMMARY

The invention is therefore based on the object of providing a battery of the type described at the outset, wherein an equal mechanical loading and/or decoupling of the battery cells arranged to form a cell stack of the battery is to be ensured over the entire service life of the battery.

The invention provides a battery of the type described at the outset for an at least partially electrically driven functional device. The battery comprises at least one battery cell module, in each of which a predetermined number of battery cells is clamped by means of a mechanical clamping device to form a cell stack. In other words, the battery cells are placed against one another or juxtaposed in such a way that they form a cell stack. For example, one to 30, in particular eight to 18, specifically 13 to 15 battery cells can be clamped to form the cell stack.

The clamping device for mechanically clamping the battery cells to form the cell stack has a first and at least one further delimiting element, wherein the first and the at least one further delimiting element are arranged on two terminal battery cells of the cell stack arranged opposite to one another. In other words, the delimiting elements are arranged outside on the two outermost battery cells of the cell stack or on the first and the last of the battery cells of the cell stack. Such a delimiting element can be embodied, for example, as a plate or a sheet, wherein in one possible embodiment such a plate or such a sheet is arranged on each of two opposing ends of the described cell stack. In order to save weight, it can be provided that multiple strips or planks are used as delimiting elements instead of a flat plate.

The clamping device is designed to transmit a traction force to the delimiting elements by means of traction elements and to pull the delimiting elements toward one another. Such a traction element can be implemented, for example, by a threaded rod, which can be guided by correspondingly formed threads on each of the delimiting elements. A traction element can also be implemented as a tie rod or a flat component in the form of a clamp, which clamps around the outside of the delimiting elements and pulls them together in this manner. The traction force can be provided, for example, by mechanically pre-tensioning the traction element. In other words, the traction element can be designed as an elastic component which is fastened on the delimiting elements in a pre-tensioned state. In this way, a contact pressure corresponding to the traction force is transmitted to the battery cells. The pre-tension can be, for example, in the range between 15 and 25 kilonewtons (kN), in particular 20 kN. The traction element is preferably fastened in a nondestructively detachable manner to the first and the at least one further delimiting element. However, the traction element can also be welded to the first and the at least one further delimiting element or connected in another manner which is not nondestructively detachable.

By transmitting the traction force to the delimiting elements, a contact pressure corresponding to the traction force is transmitted to the battery cells of the cell stack. In this way, operational swelling of the battery cells is counteracted in a fundamentally known manner.

The invention is distinguished in that frame elements are arranged between the battery cells, wherein two adjacent battery cells are spaced apart from one another by a respective frame element. In other words, battery cells and frame elements are thus alternately arranged. Two successive or adjacent battery cells are accordingly spaced apart from one another by a respective frame element or separated from one another by this. The respective frame element comprises a circumferential part and a free volume delimited by the circumferential part. Similarly to a picture frame, the circumferential part thus forms the actual frame of the frame element and the free volume forms the part of the frame element in which the respective image would be visible in a picture frame. The thickness of the respective frame element is preferably between 0.5 and ten mm (millimeters), in particular between 0.5 and five mm. The thickness of the respective frame element defines a minimum distance between two battery cells spaced apart by the frame element. Since the battery cells are preferably thermally insulated from one another, the frame element is preferably made of a thermally insulating material, for example, a plastic or ceramic composite material. The frame element can be made from an incompressible or a partially compressible or an elastic material, in particular from a rubber. The frame element is preferably manufactured from a thermally and/or electrically insulating material or is coated using such a material.

The frame element is now designed to transmit, by means of the circumferential part, the contact pressure to the adjacent battery cells spaced apart from one another by the respective frame element. In other words, the circumferential part is clamped or compressed by the contact pressure between the battery cells spaced apart by the frame element, wherein it transmits the contact pressure to the battery cells. The free volume delimited by the circumferential part between the battery cells is kept free of the contact pressure here, however.

The invention has the advantage that an operational deformation or swelling of the battery cells can take place within the free volume between the battery cells, which is kept free from the contact pressure, without the deformation resulting in a deformation in the form of a longitudinal expansion of the cell stack. In other words, a swelling that occurs does not influence an external dimension of the cell stack, so that a uniform mechanical loading of the battery cells of the cell stack is ensured. The swelling can thus take place within the free volume kept free from the contact pressure, without there being a longitudinal expansion of the cell stack and the accompanying above-mentioned disadvantageous relative movement between the cell poles of the individual battery cells and a contacting means which connects the cell poles in an electrically conductive manner, for example an electrically conductive rail. Cell module connectors between individual batteries all modules of the battery also do not have to compensate for movements or a length change induced by swelling.

The presence of the free volumes between the battery cells prevents disadvantageous transmission of deformations from battery cell to battery cell, so that each battery cell is subjected to comparable environmental conditions. This advantageously results in a lengthened service life and/or a lower risk of failure of the battery cells. Any screws or other fixing means possibly arranged to fix the cell stack in the battery are also not unevenly loaded.

In addition, the contact pressure can advantageously be selected such that it withstands a high total swelling pressure that is likely to arise in the course of the service life of the battery, wherein the battery cells themselves are spared from this high contact pressure. The contact pressure can preferably be in a range between 15 and 25 kN, in particular 20 kN. This relatively high contact pressure can advantageously be kept away from the battery cells themselves or from a respective cell chemistry by the frame elements according to the invention.

Such a frame element can also space apart the respective terminal battery cell from the respective delimiting element arranged adjacent to it. To this end, the invention provides that a respective further frame element is arranged between the first delimiting element and the terminal battery cell arranged adjacent thereto and between the at least one further delimiting element and the terminal battery cell of the cell stack arranged adjacent thereto. In other words, a frame element is also arranged between each of the delimiting elements and the respective terminal battery cell of the cell stack which is arranged adjacent to the delimiting element. In other words, a sequence of delimiting element, frame element, battery cell, and then alternately further frame elements and battery cells, and finally a frame element between the last, terminal battery cell of a cell stack and the at least one further delimiting element, result in a cell stack. This has the advantage that the first and the last battery cell of the cell stack do not have to transfer the swelling pressure or a swelling pressure caused by the operational swelling of the battery cells directly to the delimiting elements, but rather a free volume is also available towards the delimiting element. A frame element can also be arranged only between some of the battery cells. A special case provides for a single battery cell to be arranged between two delimiting elements in the “cell stack”.

The invention also includes embodiments which result in additional advantages.

One can be interested in countering the said swelling pressure with a defined counter pressure in the free volumes of the frame elements in order to control the swelling. A further embodiment provides for this purpose that a pressure-maintaining means is arranged in the free volume, which is designed to counteract in the free volume a swelling pressure caused by an operational swelling of the adjacent battery cells spaced apart from one another by the respective frame element with a counter pressure different from the contact pressure. In other words, the frame element, in particular the pressure-maintaining means arranged in the free volume of the frame element, is preferably subjected to a pressure which enables a controlled operational swelling of the battery cells. Unchecked swelling is thus advantageously prevented. In one preferred embodiment, the pressure-maintaining means can be arranged as an aerogel and/or a mechanical spring element in the free volume. The counter pressure can advantageously be set independently of the contact pressure due to the frame elements. For example, a counter pressure adapted to a respective cell chemistry of the battery cell can be produced in the free volume. In other words, an individualized counter pressure adapted to a respective aging state and/or a respective cell chemistry of the battery cell can be produced, without the contact pressure being influenced thereby.

One advantageous refinement of the invention provides that the counter pressure is greater than an atmospheric pressure prevailing in an environment of the battery and is less than the contact pressure. The prevailing atmospheric pressure or the mean air pressure of the atmosphere is normally one bar or 1013.25 hectopascals (hPa) at sea level. Advantageously, a respective battery cell can thus swell at a predetermined pressure, which is less than the contact pressure, but nevertheless greater than the prevailing mean air pressure, in a controlled manner (i.e., not unchecked), while the above-mentioned disadvantageous relative movement between the contact poles of the battery cell and the electrically conductive contacting means or rails does not occur.

According to one advantageous refinement, the pressure-maintaining means can be embodied as a compression film or compression compensation film arranged on at least one of the adjacent battery cells spaced apart from one another by the respective frame element. A compression film can be implemented, for example, by a compressible glass fiber fabric. Such a compression film advantageously opposes the swelling with a predetermined counter pressure, wherein nonetheless mechanical coupling exists between the adjacent cells.

One preferred embodiment provides that the battery cells each have a housing having housing edges and the circumferential part extends along the housing edges. In other words, the circumferential part of the frame element has the same external dimensions as a flat surface or housing side of the housing of the battery cell which is surrounded or delimited by housing edges. In the case of a rectangular surface, the circumferential part thus results in a corresponding rectangular frame. Since the region of the housing edges is many times more stable against deformations due to the structural angling predetermined by the housing edges than the flat surface of the housing, the pressure transmission of the contact pressure via the frame elements thus advantageously takes place in a stable region of the battery cell or in a region having a large bending moment. In other words, the frame element is arranged on the battery cell in such a way that the comparatively unstable flat surface, which has a lower bending moment than the region of the housing edges of the housing, is arranged opposite to a respective free volume. Bulging or swelling of the battery cell can thus take place in the region of the flat surface.

According to a further embodiment, the respective frame element is formed at least in sections as part of an outer shell of at least one of the adjacent battery cells spaced apart from one another by the respective frame element. In other words, the respective frame element is part of one of the adjacent battery cells. In other words, the frame element can be stamped on the respective battery cell. In this case, heat transfer between the battery cell and the frame element is preferably blocked. This can be implemented, for example, by a thermally insulating intermediate layer. The described embodiment advantageously results in a particularly simple assembly of the battery.

With regard to the assembly, there are still further embodiments which ensure a simplified production of the combination of battery cells and frame elements to be arranged between them. According to a further embodiment, a respective traction element is designed as a side plate extending in the direction of the traction force along the cell stack. A respective frame element is preferably connected in a friction-locked manner to the side plate in a predetermined connection region here. In other words, the respective frame element is fastened in the predetermined connection region to the side plate and is thus held in the predetermined connection region.

Alternatively or additionally, the respective frame element is connected in a formfitting manner to the side plate in the predetermined connection region. The form fit can be produced in this case, for example, in that the frame element is inserted or pushed into a notch or depression or groove in the predetermined connection region of the side plate. It can also be provided that the notch or depression or groove has an undercut into which the respective frame element can be pushed or hooked. This advantageously results in a stable connection, which can be detached nondestructively, however. This enables, for example, a simple replacement of frame elements and/or defective battery cells.

Alternatively or additionally, the respective frame element can be materially bonded to the side plate in the predetermined connection region. A material bond can be, for example, an adhesive bond or a welded bond or a soldered bond. The advantage thus results that the connection of frame element and side plate is particularly stable.

It can also be provided that the respective frame element can be inserted individually or freely between two adjacent battery cells of the cell stack. In the latter case, the frame element is exclusively held in place in the region of the circumferential part by the contact pressure. The advantage thus results of particularly flexible assembly of the battery.

According to one advantageous refinement, a plurality of frame elements is connected to the side plate. In other words, the composite of side plate and the plurality of frame elements represents a type of comb. The individual frame elements are each arranged spaced apart from one another at a predetermined distance here, wherein the distance corresponds to a width of the battery cells of the cell stack. In other words, the frame elements are each arranged spaced apart from one another, wherein a respective distance between two adjacent frame elements corresponds to a width of a respective battery cell of the cell stack. The battery cells arranged between the frame elements are thus advantageously fixed in their respective position within the cell stack.

One embodiment provides that the battery cells are designed as prismatic battery cells. Prismatic battery cells have a housing which can be deep-drawn, for example, in a deep-drawing method. Such a housing generally has a wall thickness of 0.5 to 2 mm, in particular 1 mm, and moreover does not have a high inherent rigidity. In an alternative embodiment, the battery cells can also be designed as so-called pouch cells. Pouch cells have a thin-walled and flexible cell bag as a housing. The advantage thus results that pouch cells have a lower weight than prismatic cells. However, due to their thin-walled housing, pouch cells are sensitive to pressure and, like the prismatic battery cells, do not have a high degree of inherent rigidity. The battery elements are protected from high pressures, in particular a high contact pressure, by the frame elements according to the invention. A respective pressure medium, for example, a compression film, can thus, on the one hand, be introduced without pressure between the battery cells. In addition, the less inherently rigid prismatic cells and/or the pressure-sensitive pouch cells can also be installed and their weight advantage can be used. In particular for the case that the functional device is designed as an at least partially electrically driven motor vehicle, it is particularly advantageous to reduce the weight of the battery in order to extend a range of the motor vehicle.

In addition, the invention also relates to a functional device having a battery according to the invention.

The invention also includes refinements of the functional device according to the invention which have features as have already been described in conjunction with the refinements of the battery according to the invention. For this reason, the corresponding refinements of the functional device according to the invention are not described again here.

The functional device is preferably an at least partially electrically driven motor vehicle. The motor vehicle is preferably designed as an automobile, in particular as a passenger car or truck, or as a passenger bus or motorcycle, which has an at least partially electric drive. The functional device can, for example, also be a stationary accumulator.

The invention also comprises the combinations of the features of the described embodiments.

### BRIEF DESCRIPTION OF THE DRAWINGS

Exemplary embodiments of the invention are described hereinafter. In the figures:

FIG. 1 shows a schematic top view of a battery according to the invention arranged in a functional device according to one preferred embodiment;

FIG. 2 shows a side schematic exploded view of a battery cell, a frame element, and a pressure-maintaining means;

FIG. 3 shows a schematic illustration of a battery having undeformed battery cells and a schematic illustration of a battery having battery cells deformed by swelling in comparison.

The exemplary embodiments explained hereinafter are preferred embodiments of the invention. In the exemplary embodiments, the described components of the embodiments each represent individual features of the invention to be considered independently of one another, which each also refine the invention independently of one another. Therefore, the disclosure is also intended to include combinations of the features of the embodiments other than those shown. Furthermore, the described embodiments can also be supplemented by further features of the invention that have already been described.

In the figures, the same reference numerals each designate elements that have the same function.

### DETAILED DESCRIPTION

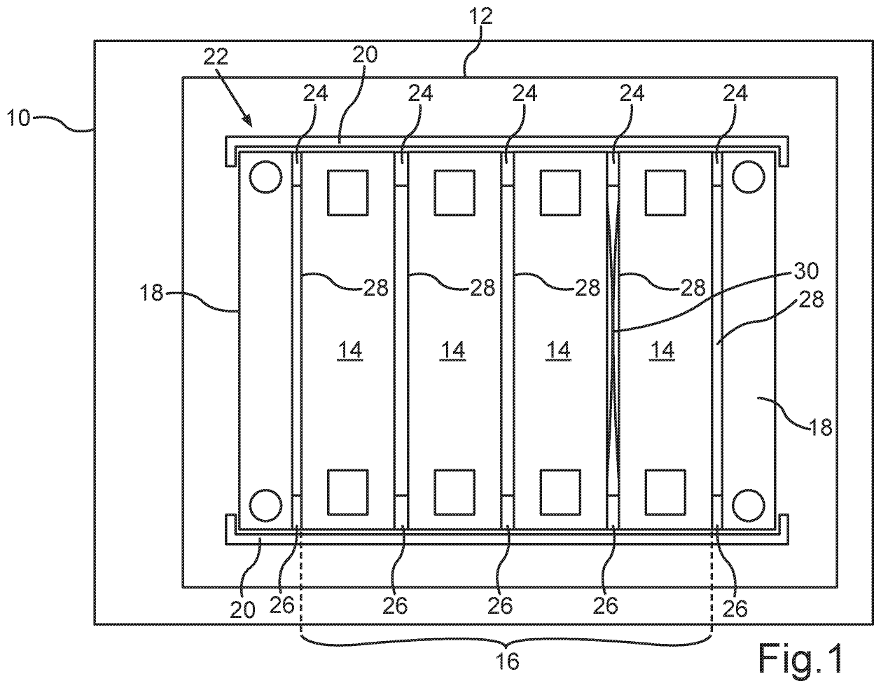

FIG. 1 shows a schematic illustration of a functional device 10 having a battery 12 according to the invention. The functional device 10 can be designed as an at least partially electrically driven motor vehicle. For the sake of simplicity, the complete battery 12 is not shown in detail in FIG. 1, but rather only a cell stack 16, which comprises four battery cells 14 here by way of example. The cell stack 16 is delimited on each of two opposing sides in the embodiment shown in FIG. 1 by a delimiting element 18. The cell stack 16 is enclosed on each of two further sides, which are also opposite to one another, by a traction element 20. The delimiting elements 18 and the traction elements 20 are embodied as parts of a clamping device 22 which mechanically clamps the battery cells 14.

Frame elements 24 are also arranged between the battery cells 14 and between a respective terminally arranged battery cell 14 and a delimiting element 18 arranged adjacent to the terminally arranged battery cell 14. In other words, for the cell stack 16 shown in FIG. 1, an alternation results of frame elements 24 and battery cells 14. A frame element 24 is also arranged between the delimiting element 18 arranged on the outside left in FIG. 1 and the terminally arranged battery cell 14 on the outside left in FIG. 1. In a similar way, a frame element 24 is also arranged between the delimiting element 18 arranged on the outside right in FIG. 1 and the terminally arranged battery cell 14 on the outside right. In one preferred embodiment, for example, a frame element 24 can only be arranged between every second battery cell 14 and the adjacent battery cells 14. In other words, a change from a double pack of two battery cells 14 and one frame element 24 would then result in each case. The respective frame element 24 would have to be correspondingly thicker in this embodiment.

Each of the frame elements 24 comprises a circumferential part 26 and a free volume 28 delimited by the respective circumferential part 26. A pressure-maintaining means 30 in the form of a compression film or compression compensation film is arranged by way of example in each of the free volumes 28 in FIG. 1. For the sake of clarity, only one pressure medium 30 is identified in FIG. 1. As described above, the compression film is compressed in FIG. 1 in one of the free volumes 28 as a result of an operational swelling of the adjacent battery cells 14 and assumes a biconcave shape.

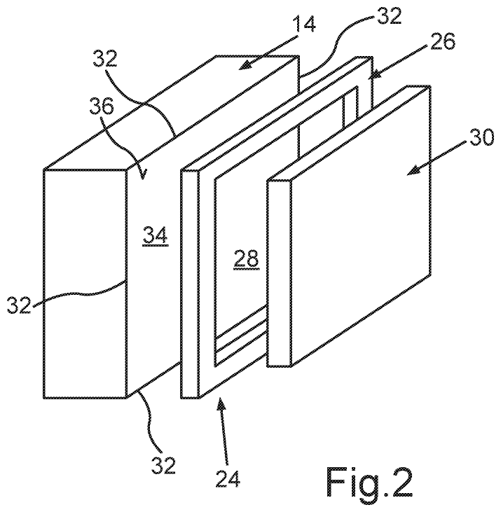

FIG. 2 shows, with reference to the components shown and described in conjunction with FIG. 1, a schematic side exploded view of an exemplary arrangement consisting of a battery cell 14, a circumferential part 26, a free volume 28 encompassed by the circumferential part 26, and a pressure-maintaining means 30. The circumferential part 26 and the free volume 28 are components of a frame element 24 here. In contrast to the embodiment of the pressure-maintaining means 30 in the form of a compression film shown in FIG. 1, FIG. 2 shows a substance filling the free volume 28, for example, a fluid or a gel, as the pressure-maintaining means 30. The pressure-maintaining means 30 can also be designed as an aerogel. An aerogel is a highly porous solid based on silicate, in which up to 99.98 percent of the volume consists of pores. The pressure-maintaining means 30 can, however, also be implemented by a foam or a polyurethane foam or a rubber. The pressure-maintaining means 30 can also be implemented as a mechanical spring element.

FIG. 2 additionally clearly shows the extension or the course of the circumferential part 26 along the housing edges 32 of the housing 34 of the battery cell 14. The flat, preferably large side surface 36 of the housing 34 is largely not concealed or covered by the circumferential part 26. The advantage thus results that the battery cell 14 can expand in the region of the free volume 28 delimited by the circumferential part 26. When expanding or swelling, the housing 34 is only opposed by the counter pressure exerted by the pressure-maintaining means 30. As described above, this counter pressure can preferably be greater than a prevailing atmospheric pressure and less than the contact pressure, i.e., less than the pressure applied by the traction forces of the traction elements 20.

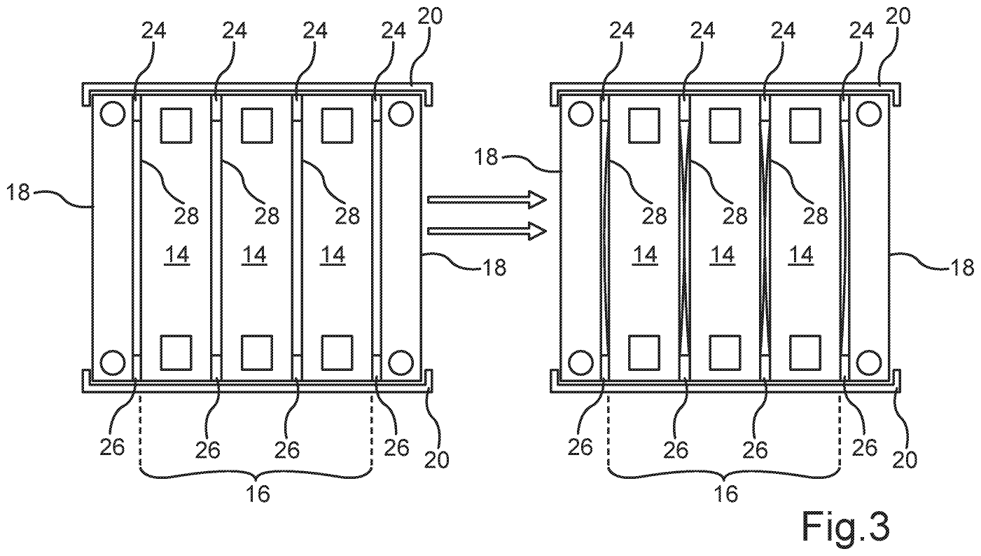

FIG. 3 shows a cell stack 16 on the left side with reference to the components shown and described in conjunction with FIG. 1 and FIG. 2, wherein the battery cells 14 arranged in the cell stack 16 do not have deformation. On the right side, in contrast, FIG. 3 shows a cell stack 16, wherein the battery cells 14 arranged in the cell stack 16 display an operational swelling. The deformation of the battery cells 14 as a result of the swelling in the free volume 28 arranged in each case between the battery cells 14 is absorbed by the frame elements 24 according to the invention. In this way, a longitudinal expansion of the entire cell stack 16 is advantageously avoided.

As is known, for example, lithium-ion cells or battery cells having a different cell chemistry are installed in various packing forms in high-voltage batteries or batteries 12, which are generally used as electric energy accumulators for at least partially electrically driven functional devices 10, for example, for at least partially electrically driven motor vehicles. These battery cells 14 can be designed, for example, as round cells, as prismatic cells, or as pouch cells.

A defined or predetermined pressure on the battery cells 14 is necessary in order to enable controlled swelling of the battery cells 14. Unchecked swelling and also completely suppressed swelling result in a reduced service life of the battery cells 14.

Known and previously installed cell stacks 16 having prismatic battery cells 14 generally consist of a serial juxtaposition of battery cells 14, which are electrically and thermally insulated from one another, are adhesively bonded to one another, and are clamped between two end plates or delimiting elements 18. This cell stack 16 or this serial sandwich is held together by two external sheets or side plates or traction elements 20. The side plates or traction elements 20 are installed with a slight pre-tension and connected to the end plates. During the first charging procedure of a cell stack 16 thus assembled, the operational swelling of the battery cells 14 begins and the battery cells 14 inflate. The resulting pressure forces are absorbed by the side plates as traction forces. On the one hand, this results in a compression of all elastic materials within the cell stack 16, on the other hand in an elongation and thus extension of the side plates or traction elements 20. As a result, an elongation of the cell stack 16 results due to the swelling.

A disadvantage of this known arrangement is that, for example, due to a screw connection of the cell stack 16 to a bottom of the battery 12, swelling of the cell stack 16 is prevented on the bottom of the battery 12. The cell stack 16 having an originally rectangular cross section deforms into an isosceles trapezoid. Swelling and the resulting inclination have an adverse effect on the entire construction. For example, an inhomogeneous pressure load leads to faster aging within the battery cell 14. In addition, the deformations within the cell stack 16 add up, outer battery cells 14 are deformed more strongly than inner ones. The contact poles or cell poles or electrical terminals, which are electrically interconnected via busbars, move in relation to one another and result in plastic deformations of the busbars. The deformation forces of the busbars are introduced into the contact poles and result in deformations and possibly leaks in the interface between contact pole and battery cell 14. The relative movements mentioned of the cell stack 16 or of the entire battery cell modules within the battery must be compensated for by cell module connectors. In addition, the mechanical stability in the event of any mechanical force action, for example, vibration/shock or in case of crash (for example, as a result of an accident of a functional device 10 designed as an at least partially electrically driven motor vehicle) is dependent on the present swelling forces in the battery cell module or in the cell stack 16.

Further concepts for the arrangement are known, which provide, for example, a compensation element or a compressible intermediate layer within the cell stack 16, which can be arranged between the outer battery cells 14 and the end plates or delimiting elements 18. In these concepts, the external dimensions are constant and there is no inclination of possibly provided fastening screws. However, the problem of the deformation forces on the bus bars, the introduction of force into the cell poles, and the inhomogeneous pressure loading on the battery cells 14 remain unchanged.

In one preferred embodiment of the invention, the basic structure of a cell stack 16 is similar to that in known concepts, but the elastic insulating foils (for example aerogel and/or spring element and/or pressure-maintaining means 30 formed from other materials) are inserted between the battery cells 14 within a rigid frame or frame element 24. This rigid frame element 24 is preferably supported on the side walls of the battery cell 14. Due to the rigid frame or frame elements 24, each battery cell 14 is fixed in its position within the cell stack 16. The swelling of each individual battery cell 14 is preferably absorbed via the pressure-maintaining means 30 between the battery cells 14, namely in the described free volume 28. The pressure-maintaining means 30 fills the cavity or the free volume 28 within the circumferential part 26 of the frame element 24. The pressure forces resulting due to the swelling equalize between the battery cells 14, the respective first and last battery cell 14 of a cell stack 16 dissipate the pressure to the end plates or delimiting elements 18 here. The side plates or traction elements 20 designed as side plates connect the end plates and are thus subjected to traction forces.

The side plates are preferably connected to the end plates in a pre-tensioned state. If, for example, swelling forces of 25 kN are expected, the side plates can be installed on the end plates with a pre-tension of 25 kN. In this way, the serial composite of end plates or delimiting elements 18, adhesive films or pressure-maintaining means 30 designed as compression films, frame or frame element 24, and battery cells 14 is subjected to a pre-tension of 25 kN. Swelling forces up to 25 kN within the cell stack 16 are absorbed by the pre-tension of the side plates, without the outer dimensions of the cell stack 16 changing or the position of the cell poles shifting in relation to one another.

In one preferred embodiment of the invention, the frame elements 24 can be components of the battery cells 14. The frame elements 24 can also be components of the side plates or can be connected to them. The pre-tensioning by the side plates can preferably only partially compensate for the swelling forces, for example, up to 50%. The expansion of the cell stack 16 is reduced by only 50% in this way. The frame elements 24 can be manufactured from a rigid or a non-rigid or elastic material. The compression films can preferably be subjected to a pre-tension of 2 kN, which can increase to up to 25 kN in the course of the service life of the cell stack 16 or the individual battery cells 14. The spacer frames or frame elements 24 are preferably pressurized with an active pressure of greater than 25 kN over the entire service life of the battery 12.

The invention results in multiple advantages. Thus, the swelling of the battery cells 14 takes place largely homogeneously, since each battery cell 14 has the same environmental conditions (results in extended service life, less risk of failure). The outer dimensions of a respective cell stack 16 (or a respective battery cell 14) do not change, or change only minimally, in the region of the screwing points of the cell stack 16 on a bottom of the battery 12, depending on how much pre-tension is applied to the side plates. In addition, the cell poles of the battery cells 14 are not subjected to forces due to relative movements over the service life of the battery 12. The module connectors between the battery cell modules within the battery 12 do not have to compensate for movements due to swelling. The screws for fixing the battery cell modules or cell stack 16 in the battery 12 do not become inclined. The cell stack 16 is also less sensitive to vibration, since all the individual parts of the cell stack 16 are held together with a constantly high force over the entire service life of the battery 12. With a suitable construction of the intermediate layers or frame elements 24 between the battery cells 14, it is possible to limit the maximum pressure force to a defined value in order to prevent a reduction in performance due to excessively high pressures (closure of the pores in the separator film).

Overall, the examples show how the invention can prevent a relative movement between the cell poles of respective battery cells 14 clamped together to form a cell stack 16. In addition, the examples show how it is possible for the invention to prevent external dimensions of a cell stack 16 from changing or only changing insignificantly as a result of swelling over the service life of the battery cells 14. An equal mechanical load of all battery cells 14 of the cell stack 16 can thus advantageously be achieved.

1. A battery for an at least partially electrically operated functional device, comprising:
at least one battery cell module, in each of which a predetermined number of battery cells are clamped to form a cell stack by a mechanical clamping device, wherein the clamping device has a first and at least one further delimiting element, wherein the first and the at least one further delimiting element are arranged on a respective battery cell of the two ends of the cell stack arranged opposite to one another and the clamping device is designed to transmit a traction force to the delimiting elements by traction elements and to pull them toward one another, whereby a contact pressure corresponding to the traction force is transmitted to the cell stack,
wherein a frame element is arranged in each case between at least two or some or each of the battery cells and/or a respective terminal battery cell and the delimiting element arranged adjacent to the respective terminal battery cell and associated with it, wherein each two adjacent ones of the battery cells are spaced apart from one another by the respective frame element and/or the respective terminal battery cell is spaced apart from the delimiting element associated with it, wherein the respective frame element includes a circumferential part and a free volume delimited by the circumferential part and is designed to transmit the contact pressure to the respective battery cell spaced apart by the frame element by the circumferential part and to keep the free volume delimited by the circumferential part free of the contact pressure.

2. The battery as claimed in claim 1, wherein a pressure-maintaining element is arranged in the free volume, and is designed to counteract in the free volume a swelling pressure caused by an operational swelling of the adjacent battery cells spaced apart from one another by the respective frame element with a counter pressure different from the contact pressure.

3. The battery as claimed in claim 2, wherein the counter pressure is greater than an atmospheric pressure prevailing in an environment of the battery and is less than the contact pressure.

4. The battery as claimed in claim 2, wherein an aerogel and/or a mechanical spring element is arranged in the free volume as the pressure-maintaining element.

5. The battery as claimed in claim 2, wherein the pressure-maintaining element is embodied as a compression film arranged on at least one of the adjacent battery cells spaced apart from one another by the respective frame element.

6. The battery as claimed in claim 1, wherein the battery cells each have a housing having housing edges and the circumferential part extends along the housing edges.

7. The battery as claimed in claim 1, wherein the respective frame element is formed at least in sections as a part of an outer shell of at least one of the adjacent battery cells spaced apart from one another by the respective frame element.

8. The battery as claimed in claim 1, wherein a respective traction element is designed as a side plate extending in the direction of the traction force along the cell stack and the respective frame element is connected in a friction-locked and/or formfitting and/or materially-bonded manner to the side plate in a predetermined connection region.

9. The battery as claimed in claim 8, wherein a plurality of frame elements is connected to the side plate, wherein the individual frame elements are each arranged spaced apart from one another at a predetermined distance, wherein the distance corresponds to a width of the respective battery cell of the cell stack.

10. The battery as claimed in claim 1, wherein the battery cells are designed as prismatic battery cells or pouch cells.

11. The battery as claimed in claim 3, wherein an aerogel and/or a mechanical spring element is arranged in the free volume as the pressure-maintaining element.

12. The battery as claimed in claim 3, wherein the pressure-maintaining element is embodied as a compression film arranged on at least one of the adjacent battery cells spaced apart from one another by the respective frame element.

13. The battery as claimed in claim 4, wherein the pressure-maintaining element is embodied as a compression film arranged on at least one of the adjacent battery cells spaced apart from one another by the respective frame element.

14. The battery as claimed in claim 2, wherein the battery cells each have a housing having housing edges and the circumferential part extends along the housing edges.

15. The battery as claimed in claim 3, wherein the battery cells each have a housing having housing edges and the circumferential part extends along the housing edges.

16. The battery as claimed in claim 4, wherein the battery cells each have a housing having housing edges and the circumferential part extends along the housing edges.

17. The battery as claimed in claim 5, wherein the battery cells each have a housing having housing edges and the circumferential part extends along the housing edges.

18. The battery as claimed in claim 2, wherein the respective frame element is formed at least in sections as a part of an outer shell of at least one of the adjacent battery cells spaced apart from one another by the respective frame element.

19. The battery as claimed in claim 3, wherein the respective frame element is formed at least in sections as a part of an outer shell of at least one of the adjacent battery cells spaced apart from one another by the respective frame element.

20. The battery as claimed in claim 4, wherein the respective frame element is formed at least in sections as a part of an outer shell of at least one of the adjacent battery cells spaced apart from one another by the respective frame element.
